(19) United States
(12) Patent Application Publication
(10) Pub. No.: US 2006/0225527 A1
(43) Pub. Date: Oct. 12, 2006

(54) Automatic transmission using a shift support system

(76) Inventors: Ching-Min Yang, Beijing (CN); Guojun Shi, Canton, MI (US)

Correspondence Address: Guojun Shi, 49016 Manhattan Circle, Canton, MI, 48188, US

(21) Appl. No.: 11/099,401

(22) Filed: Apr. 6, 2005

(51) Int. Cl. F16H 3/08

(52) U.S. Cl. 74/330

(57) ABSTRACT

An automatic transmission utilizes a shift support system using combination of coupled clutch assemblies with a fluid drive and a gear system to provide multi-speed ratios with one reverse ratio without excessive heat generation. The fluid drive has an impeller and a turbine, and each coupled clutch assembly has two respective inputs from the fluid drive impeller and turbine with one output to the gear system. Each coupled clutch assembly provides possibilities of either connection or disconnection for engine to alternatively obtain different gear ratio speeds, or drive both odd and even gears at the same time for a smooth shift transition. Utilization of the shift support system with torque transmitting elements to provide connections between different gear sets allows the transmission to be operated in higher reliability and less complicated control than dual clutch transmission with similar efficiency.

### REFERENCE CITED

| | | | |
|---|---|---|---|
| 5,106,352 A | April 1992 | Lepelletier | 475/280 |
| 5,950,781 A | September 1999 | Adamis, et al. | 192/3.61 |
| 6,463,821 B1 | October 2002 | Reed, Jr., et al | 74/330 |
| 6,571,654 B2 | June 2003 | Forsyth | 74/339 |
| 6,656,078 B1 | December 2003 | Raghavan, et al. | 475/276 |
| 6,715,597 B1 | April 2004 | Buchanan, et al. | 192/70.12 |
| 6,852,059 B2 | February 2005 | Lee, et al. | 475/286 |

### TECHNICAL FIELD

This invention relates to automatic transmissions, in particular used in motor vehicles, comprising conventional gearsets controlled by frictional elements, such as clutches coupled with a fluid drive that utilizes fluid that subjects to slip and drive without harsh shift feel, and gear shifting devices, such as synchronizers.

### BACKGROUND OF THE INVENTION

Conventional powertrain system used in a passenger vehicle is comprised of an engine, multi-speed transmission and a differential or final drive system. The premier function of transmission extends the operating range of the vehicle by allowing the engine to perform by means of its torque range several times higher than the engine torque as the transmission ratio increases and also allows the engine to perform its output speed range higher than engine speed as transmission ratio reduces, such as in the overdrive speed.

With advent of six speed automatic transmissions (U.S. Pat. Nos. 5,106,352 and 6,656,078), the step size between ratios is reduced and the shift quality of the transmission by making the ratio interchanges is substantially improved comparing with three and four speed transmissions. Multi-speed transmissions, such as six speed automatic transmissions, also have advantages over fewer speed transmissions, such as three and four speed automatic transmissions, to achieve desirable fuel economy to generate maximum power.

Such multi-speed transmissions still use the conventional torque converter for comfort shifting, but have quite low mechanical efficiency. Torque converters typically include impeller assemblies that are operatively connected with input shaft from an internal combustion engine, a turbine assembly that is fluidly connected with the impeller assembly and a stator or reactor assembly. These assemblies together form a substantially toroidal flow passage for kinetic fluid in the torque converter. Each assembly includes a plurality of blades or vanes that act to convert mechanical energy to hydrokinetic energy and back to mechanical energy. The stator assembly of a conventional torque converter is locked against rotation in one direction but is free to spin about an axis in the direction of rotation of the impeller assembly and turbine assembly. When the stator assembly is locked against rotation by so called one-way clutch, the torque is multiplied by the torque converter. During torque multiplication, the output torque is greater than the input torque for the torque converter. However, when there is no torque multiplication, the torque converter becomes a fluid coupling. Torque converter slip exists when the speed ratio is less than 1.0. The inherent slip reduces the efficiency of the torque converter. Although lock-up device is usually equipped in newly developed transmissions, only a few of gears can be locked up for saving energy and avoiding noise and vibration problems. Its overall efficiency is still low as long as the torque converter is used. Therefore, the method used to enhance the performance by increasing number of speeds almost reaches its limits and the torque converter is considered as a big technical barrier.

Automated manual transmission (AMT), another type of automatic shifting transmission used in motor vehicles, improves the efficiency by removing the torque converter. Such automated manual transmissions (U.S. Pat. No. 6,571,654) typically include a plurality of power-operated actuators that are controlled by a transmission controller or some type of electronic control unit (ECU) to automatically shift synchronized clutches that control the engagement of meshed gear wheels traditionally found in manual transmissions. It does the function of interchanging the speed ratio by automatically disengaging the clutch disc, choosing the right gear ratio, shifting to the gear and engaging clutch automatically. However, this shifting procedure causes discontinuous torque delivery and harsh shift feel to the passengers. This discomfort characteristics is the major drawback to prevent it from wide applications in motor vehicles, although the efficiency can be as good as manual transmissions.

Transmission using twin-clutch, known as dual clutch transmission (U.S. Pat. Nos. 5,950,781 and 6,463,821), also removes the torque converter to improve the mechanical efficiency. The dual clutch structure has two coaxially and cooperatively configured clutches that derive power input from a singular engine crankshaft. It consists of two independent transmission systems that have two concentric driving shafts, one is hollow and the other is solid within the hollow shaft. The first, third and fifth driving gears are on one of the driving shafts and the second, forth and sixth gears are on the other shaft. The third shaft is a driven shaft that has all the driven gears on it. The gear shifting operation is activated by dogs and sliding sleeves on driving and driven shafts. When a gear is shifted to the next gear for ratio interchange, it engages one of the clutches while the other is still in engagement. Due to the two-clutch engagement at the same time, one of them or both of them must create relative slip motion to prevent it from damaging the components in the system while the output speed takes the transition for a gradual change to the next gear. The shifting operation can give comfort feel that is similar to the one by using torque converter. The dual clutch transmission soon receives increasing popularity in the applications of passenger cars. The drawback of dual clutch transmission is that controlling and regulating the automatically actuated dual clutch transmission to achieve the desired vehicle passenger comfort goals is a complicated matter. There are a large number of events to be properly executed in terms of time for each shift to occur smoothly and efficiently. In addition, the clutch assembly working within the dual clutch transmission case generates a considerable amount of heat (U.S. Pat. No. 6,715,597). Especially, when the vehicle starts to launch and heavily loaded pressure acts on the clutch discs while slip is required for smooth transition (U.S. Pat. No. 6,463,821). The slip in dual clutch is quite high comparing to that in conventional automatic transmissions in which the clutch slip is limited between driving and driven clutch discs. These conventional automatic transmissions, either using planetary gear sets or parallel shafts with external gear sets, usually have an uncontrolled way to dissipate the heat that is generated from torque converter, clutches, gears and actuators, etc., by using a transmission fluid cooler. It has been proven to be reliable and economic for long time operations through the reduced pump pressure to circulate the flow. However, in the dual clutch transmission, since more heat can be generated in a short time, this cooling methodology is unable to serve the system to maintain the required fluid temperature. The requirements for the materials in friction elements are also high and the way to cool the transmission fluid and its control procedures are much more complicated (U.S. Pat. No. 6,715,597). Although dual clutch transmission provides high mechanical efficiency and comfort shifting quality, these disadvantages only allow it to be used in limited types of lighter duty vehicles. In addition, it leads to lower reliability than the conventional automatic transmissions unless more advanced materials and more complicated system with additional cooling device are used to ensure acceptable service life and reliable operation.

The objective of this invention is to provide a new transmission system by overcoming the disadvantages in automatic transmissions, automated manual transmissions (AMT) and dual clutch transmissions. By using suitable combination of reliable fluid drive and coupled clutches, it provides similar mechanical efficiency as in automated manual transmissions (AMT) and dual clutch transmissions, comfort shift quality and efficient heat dissipation as widely used in conventional automatic transmissions, low material requirements for the friction elements and reliable operation with reduced control complexity.

### SUMMARY OF THE INVENTION

It is an object of the present invention to provide automatic transmissions using a shift support system for multi-step forward speed ratios and one reverse speed ratio.

In one aspect of the present invention, the transmission incorporates a gear system, a shift support system and engageable torque-transmitting components.

In another aspect of the present invention, the gear system contains first and second gear subsystems.

In another aspect of the present invention, the first and second gear subsystems have one common output shaft and have first and second input shafts, respectively.

In another aspect of the present invention, shift support system contains two coupled clutch assemblies and a fluid drive.

In another aspect of the present invention, each coupled clutch assembly has first and second coupled clutches.

In another aspect of the present invention, each clutch in the coupled clutch assembly has driving and driven clutch discs.

In another aspect of the present invention, the driven clutch discs of first and second clutches in each coupled clutch assembly are continuously coupled.

In another aspect of the present invention, the fluid drive contains an impeller and a turbine.

In another aspect of the present invention, each coupled clutch assembly enables either the first clutch driving disc connection with the fluid drive impeller or no connection.

In another aspect of the present invention, each coupled clutch assembly enables either the second clutch driving disc connection with the fluid drive turbine or no connection.

In another aspect of the present invention, driven clutch discs of the first coupled clutch assembly continuously connects with the input shaft of the first gear subsystem.

In another aspect of the present invention, driven clutch discs of the second coupled clutch assembly continuously connects with the input shaft of second gear subsystem.

In another aspect of the present invention, first of four engageable torque-transmitting components selectively connects the first or third driving gears with input shaft in the first gear subsystem.

In another aspect of the present invention, second of four engageable torque-transmitting components selectively connects the second driving gear in the first gear subsystem or fifth driving gear in the second gear subsystem with the common output shaft of the gear system.

In another aspect of the present invention, third of four engageable torque-transmitting components selectively connects the fourth or sixth driving gears in the second gear subsystem with the output shaft of the gear system.

In another aspect of the present invention, fourth of four engageable torque-transmitting components selectively connect the reverse driving gear with input shaft in the first gear subsystem.

### BRIEF DESCRIPTION OF THE DRAWINGS

FIG. 1 is a schematic representation of a six speed automatic transmission using a shift support system.

FIG. 2 is a schematic representation for the first gear in the transmission described in FIG. 1.

FIG. 3-1 is a schematic representation of the first shifting stage: preparation for gear shifting from gear 1 to gear 2: shift to 2^{nd} gear under no load while 1^{st} gear is still engaged.

FIG. 3-2 is a schematic representation of the second shifting stage: first transition for gear shifting from gear 1 to gear 2: 2^{nd} gear engages with fluid drive while 1^{st} gear is still engaged.

FIG. 3-3 is a schematic representation of the third shifting stage: the second transition for gear shifting from gear 1 to gear 2: 1^{st} gear is disengaged while engaged 2^{nd} gear is driven by fluid drive.

FIG. 3-4 is a schematic representation of the fourth shifting stage: completion of gear shifting from gear 1 to gear 2: fluid drive engagement is removed and 2^{nd} gear is directly driven by the engine.

FIG. 4 is a synchronizer engagement schedule.

FIG. 5-1 is a schematic representation for gear shifting from odd gear to even gear. (a) Shift preparation (b) First transition (c) Second transition (d) Shift completion

FIG. 5-2 is a schematic representation for gear shifting from even gear to odd gear. (a) Shift preparation (b) First transition (c) Second transition (d) Shift completion

FIG. 6-1 is rotating speed difference between fluid drive impeller and turbine when up shift.

FIG. 6-2 is rotating speed difference between fluid drive impeller and turbine when down shift.

FIG. 7 is a schematic representation of a four speed automatic transmission using a shift support system.

FIG. 8 is a schematic representation of a five speed automatic transmission using a shift support system.

FIG. 9 is a schematic representation of a seven speed automatic transmission using a shift support system.

### DESCRIPTION OF PREFERRED EMBODIMENTS

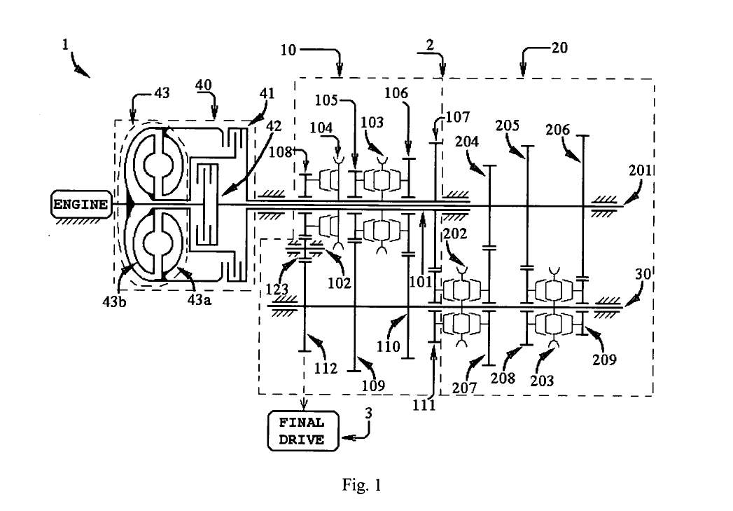

Referring to the drawings, wherein like characters represent the same or corresponding components throughout the several views, there is shown in FIG. 1, a powertrain system 1 having a conventional engine, a six-speed transmission 2, and a conventional final drive mechanism 3.

The six-speed transmission 2 includes a shift support system 40, which includes two coupled clutch assemblies 41 and 42 and a fluid drive 43, and a gear system, which includes first subsystem 10 and second subsystem 20. The fluid drive 43 includes impeller 43a, which is continuously interconnected with the output shaft of engine, and the turbine 43b, which is selectively interconnected with either coupled clutch assemblies 41 or 42 or both. The first gear subsystem includes a hollow shaft 101 with gears 105, 106, 107 and 108, in which gears 105, 106 and 108 are free to rotate, but 107 is fixed on 101. The second gear subsystem also includes a shaft 201, which goes through shaft 101, and gears 204, 205 and 206, which are fixed on 201. Two synchronizers, 103 and 104, are included in the first gear subsystem 10 and other two synchronizers, 202 and 203, are included in the second gear subsystem 20. Shaft 30 is an output shaft, in which driven gears 111, 207, 208 and 209 are installed for free rotating and driven gear 109, 110, 112 are fixed. Shaft 102 can be a fixed shaft without rotation to support an idler gear 123.

The synchronizer, 103, can be controlled to make three possible connections described as follows:

1. Connection between gear 105 and shaft 101

2. Connection between gear 106 and shaft 101

3. No connection

Another synchronizer 104 on shaft 101 can also be controlled to make two possible connections described as follows:

1. Connection between gear 108 and shaft 101

2. No connection

Another synchronizer 202 on shaft 30 can also be controlled to make three possible connections described as follows:

1. Connection between gear 111 and shaft 30

2. Connection between gear 207 and shaft 30

3. No connection

Another synchronizer 203 can be controlled to make three possible connections described as follows:

1. Connection between gear 208 and shaft 30

2. Connection between gear 209 and shaft 30

3. No connection

The gear, 123, which is free to rotate on shaft 104, serves as an idler that rotates for the purpose of changing the rotation direction of 112.

Shaft 30 serves as an output shaft to give the rotation speed and torque to the final drive mechanism, which usually includes reduction gears and differential system.

First coupled clutch assembly 41 includes two clutches, in which their driven discs are coupled each other to be connected with shaft 101. The two inputs are from fluid drive impeller 43a and turbine 43b, respectively. They can be connected or disconnected independently as the controlled hydraulic pressure changes. Therefore, four possible connections can be generated between the driving and driven discs described as follows:

1. Fluid drive impeller 43a connects with shaft 101

2. Fluid drive turbine 43b connects with shaft 101

3. Both fluid drive impeller 43a and turbine 43b connect with shaft 101

4. No connection

Second coupled clutch assembly 42 has the same configuration as 41, but has the single output to shaft 201. It also has four possible connections described as follows:

1. Fluid drive impeller 43a connects with shaft 201

2. Fluid drive turbine 43b connects with shaft 201

3. Both fluid drive impeller 43a and turbine 43b connect with shaft 201

4. No connection

As results of the arrangement of two coupled clutch assemblies and fluid drive of the present invention, the transmission system is alternatively engaged to provide odd number and even number speed ranges, respectively.

As mentioned above, the first and second coupled clutch assemblies 41 and 42 are alternatively engaged for transmitting power from engine to either gear subsystem 10 or gear subsystem 20. The first and second coupled clutch assemblies 41 and 42 are controlled electronically, and the coupled clutch assemblies 41 and 42 in disengaged or engaged combinations with fluid drive gives maintained shift quality and facilitates transfer of power from one transmission subsystem to another.

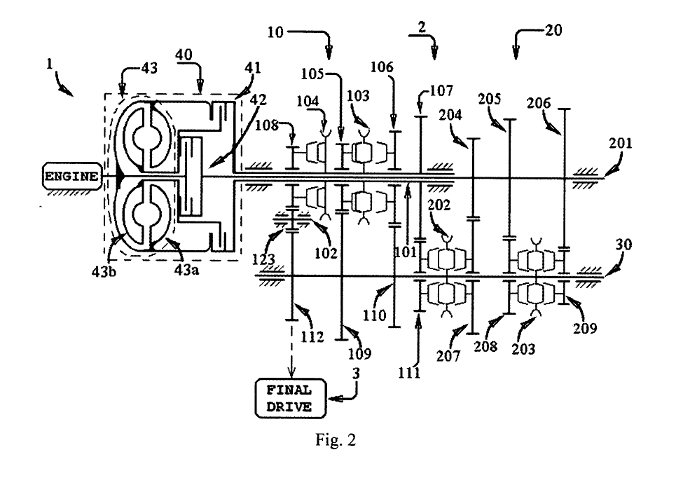

The above description can be illustrated by an example in which the transmission shifts from first gear to the second gear. At the beginning, the first gear is used for the engine to give rotating speed and torque to shaft 101 through coupled clutch assembly 41. The power is delivered from the synchronizer 103 to gear 105. As shown in FIG. 2, since gear 105 engages with gear 109 for the first gear ratio and 109 and 112 are fixed on shaft 30, the power is delivered from shaft 30 to final drive mechanism. The coupled clutch assembly 42 is also engaged to drive shaft 201 under no load. The following four steps is described in details for gear shift process:

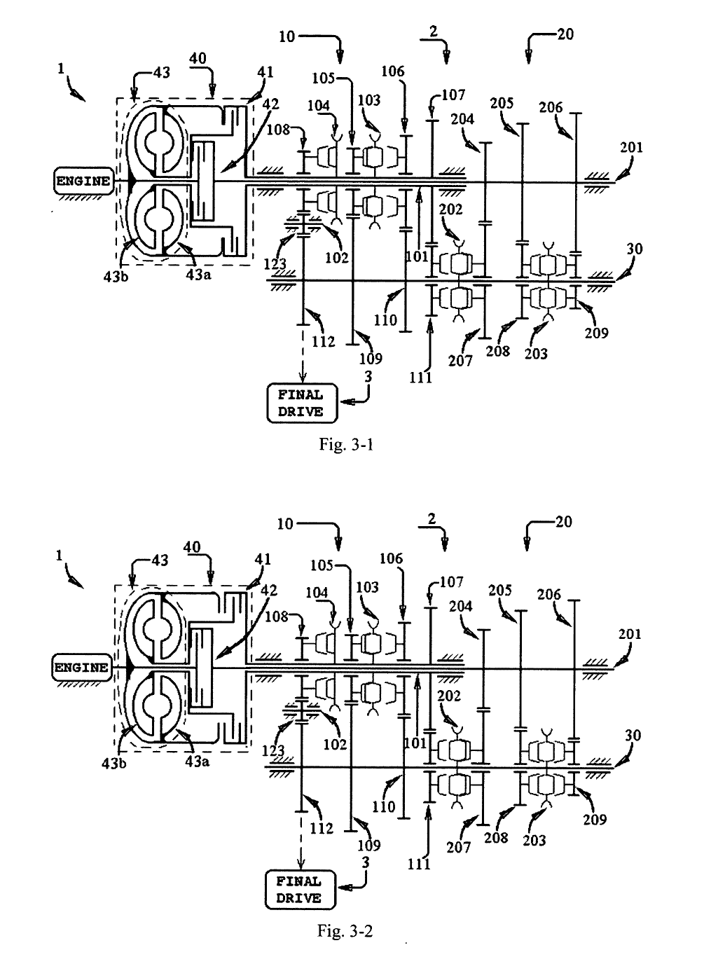

Step 1: Preparation for shift. First, electronic control system (omitted from the figure) gives command to disengage the second couple clutch assembly 42 and then use synchronizer 202 to make connection between gear 207 and shaft 30 under no load. After that, the second coupled clutch assembly 42 is used to connect fluid drive turbine 43b with shaft 201. At this moment, although gear 105 engages with gear 109 for the first gear ratio and gear 204 engages with gear 207 for the second gear ratio, there is no interference between the gears because fluid drive has fluid slip between impeller 43a and turbine 43b. The output speed is still the first gear speed, shown in FIG. 3-1.

Step 2: The first transition. The electronic control system gives command to disengage the coupled clutch assembly 41. Since the first gear has no load, synchronizer 103 can be disengaged after disengagement of 41. The fluid drive turbine 43b drives the second gear through the engagement of gear 204 and gear 207. The output speed gradually increases by the fluid drive, shown in FIG. 3-2.

Step 3: The second transition. The electronic control system gives command to operate second coupled clutch assembly 42 to gradually connect fluid drive impeller 43a with shaft 201, shown in FIG. 3-3. At the same time, the connection between shaft 201 and fluid drive turbine 43b is maintained to provide the second gear speed. At the moment, the fluid drive loses its function since the impeller 43a and turbine 43b have the same speed.

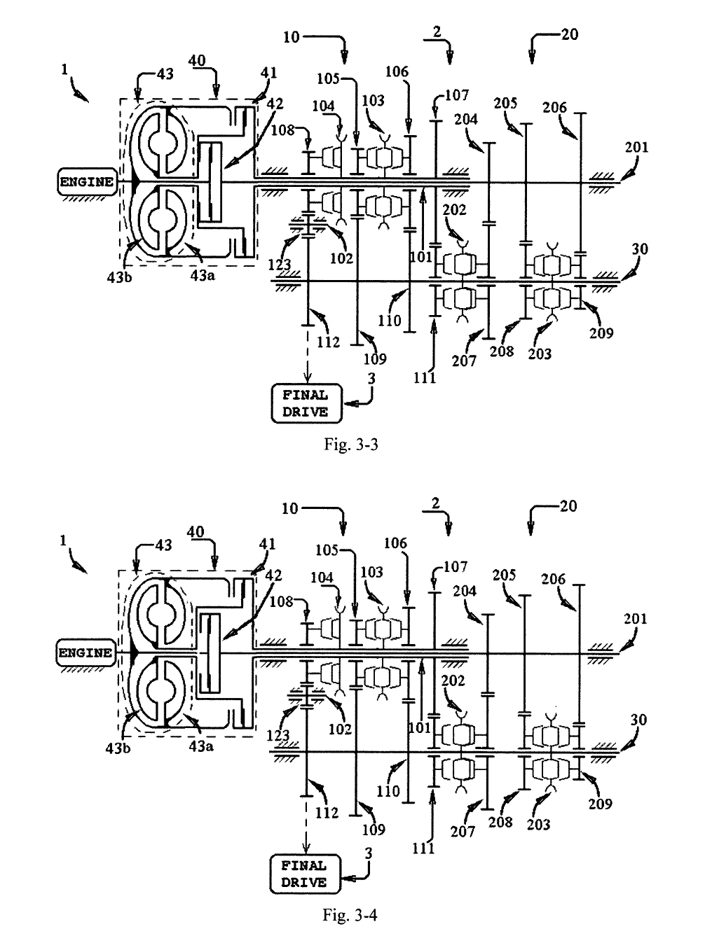

Step 4: Completion of shift. The electronic control system gives command to operate second coupled clutch assembly 42 to gradually disconnect fluid drive turbine 43b with shaft 201. At the moment, the impeller 43a drives the second gear directly through the engagement of synchronizer 202 and connection between gears 204 and 207, shown in FIG. 3-4. First coupled clutch assembly 41 connects fluid drive turbine 43b with shaft 101 for preparation to next gear under no load.

In this manner, shift quality is maintained with smooth transition for gear ratio change from one to the other in the automatic transmission, while providing better fuel economy with no torque interrupts. Unlike torque converter to drive a motor vehicle frequently to cause low efficiency in conventional automatic transmissions, direct drive is used to drive a motor vehicle and fluid drive in the present invention is just used for shifting gears.

Similarly, above steps for shifting gears, except launching and the reverse gear, are also valid for shifting one gear to the adjacent gear. By changing the synchronizer's positions, different gear ratios can be achieved. FIG. 4 shows the positions of four synchronizers for the engagement schedule to generate different gear ratios.

It is the same principle for the gears to shift from even number gears to odd number gears, but the engagement and disengagement for coupled clutch assemblies is in a different order. The difference between to shift from odd number gears to even number gears and to shift from even number gears to odd number gears using shift support system 40 can be illustrated in FIGS. 5-1 and 5-2.

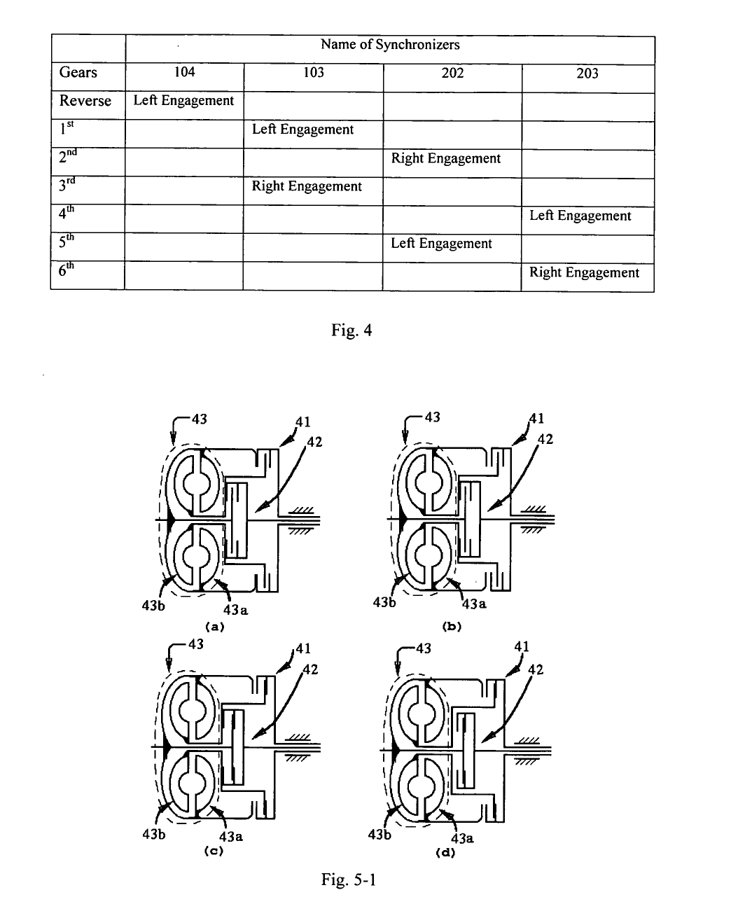

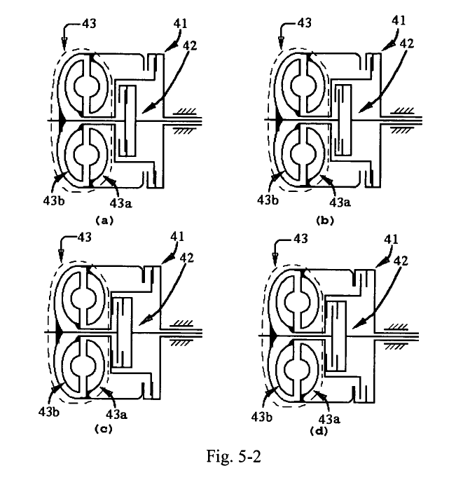

Shift from an odd gear to an even gear:
1. Preparation for shifting. Disconnect the first coupled clutch assembly 42 and then use synchronizer to connect the even gear with shaft 30 under no load. Then, second coupled clutch assembly 42 reconnects the fluid drive turbine 43b with shaft 201, shown in FIG. 5-1a.
2. The first transition. First coupled clutch assembly 41 disengages and the fluid drive turbine 43b drives the even gear, shown in FIG. 5-1b.
3. The second transition. Second coupled clutch assembly 42 to gradually connect fluid drive impeller 43a to shaft 201. The fluid drive impeller 43a and turbine 43b drive the even gear at the same time, shown in FIG. 5-1c.
4. Completion of shifting. Second coupled clutch assembly 42 disconnects the fluid drive turbine 43b with shaft 201 and the impeller 43a drives the even gear directly, shown in FIG. 5-1d.

Shift from an even gear to an odd gear:
1. Preparation for shifting. Disconnect second coupled clutch assembly 41 and use synchronizer to connect the odd gear with shaft 30 under no load. Then, first coupled clutch assembly 41 reconnects the fluid drive turbine 43b with shaft 101, shown in FIG. 5-2a.
2. The first transition. Second coupled clutch assembly 42 disengages and the fluid drive turbine 43b drives the odd gear, shown in FIG. 5-2b.
3. The second transition. First coupled clutch assembly 41 gradually connects fluid drive impeller 43a with shaft 101. The fluid drive impeller 43a and turbine 43b drive the odd gear at the same time, shown in FIG. 5-2c.
4. Completion of shifting. First coupled clutch assembly 41 disconnects the fluid drive turbine 43b with shaft 101 and the fluid drive impeller 43a drives the odd gear directly, shown in FIG. 5-2d. Second coupled clutch assembly 42 connects with fluid drive turbine 43b under no load to prepare for next gear.

During launching or reverse gear shifting using shift support system 40, only three steps are needed. The launching procedures are described as follows:
1. Preparation for launching. Synchronizer 103 connects the first gear to shaft 30 under no load. Then, first coupled clutch assembly 41 connects the fluid drive turbine 43b with shaft 101.
2. The transition. First coupled clutch assembly 41 to gradually connect fluid drive impeller 43a with shaft 101. The fluid drive impeller 43a and turbine 43b drive the first gear at the same time.
3. Completion. First coupled clutch assembly 41 disconnects the fluid drive turbine 43b with shaft 101 and the fluid drive impeller 43a drives the first gear directly. Second coupled clutch assembly 42 connects with fluid drive turbine 43b under no load to prepare for next gear.

The reverse gear shifting can use the similar description by replacing the first gear with reverse gear from above.

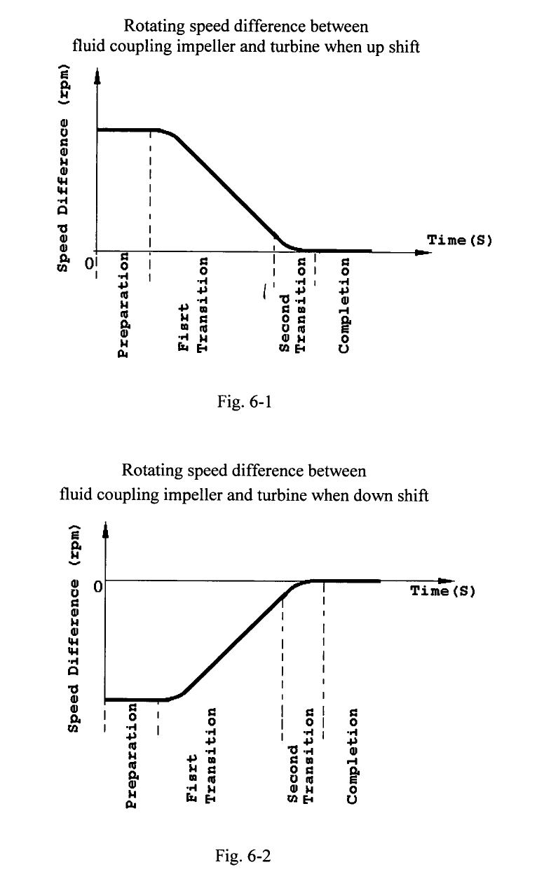

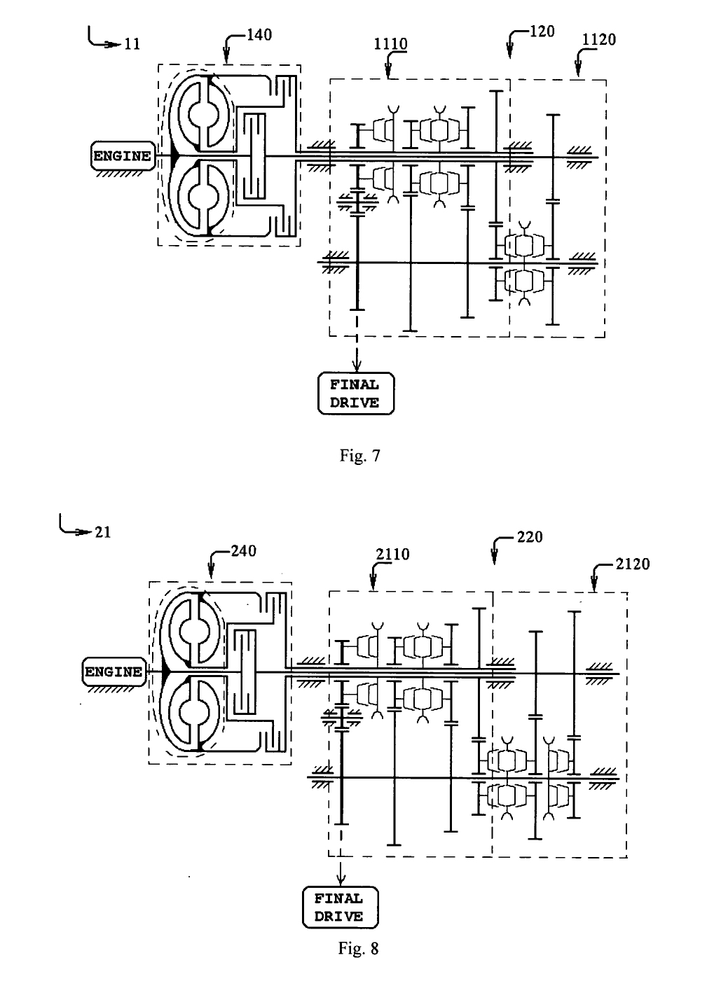

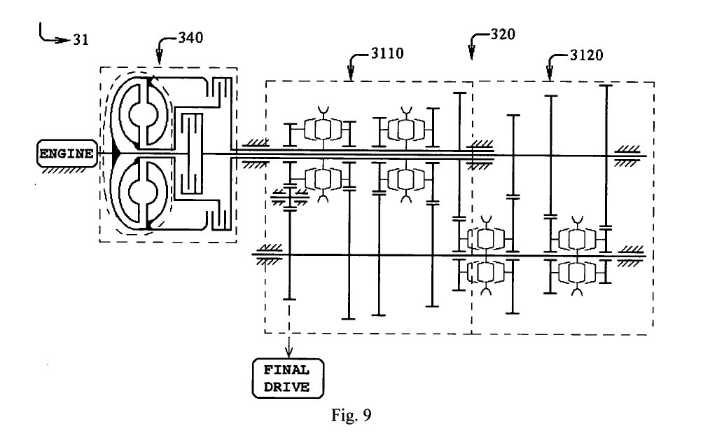

Based on above principle, multi-speed automatic transmissions using shift support system 40 can be derived into several types in order to be used in different applications. A four-speed automatic transmission, which includes a shift support system 140 and a gear system 120 containing two gear subsystems 1110 and 1120, is shown in FIG. 7, a five-speed automatic transmission, which includes a shift support system 240 and a gear system 220 containing two gear subsystems 2110 and 2120, is shown in FIG. 8 and a seven-speed automatic transmission, which includes a shift support system 340 and a gear system 320 containing two gear subsystems 3110 and 3120, is shown in FIG. 9.

In summary, since an advantage is taken by replacing the dual clutch friction in a dual clutch transmission with non-contact fluid friction, the friction between clutch discs is greatly reduced with less heat generation. It is important for such friction reduction to prevent discs from wear and seizure failures with lower requirement of materials in order to ensure the system reliability and low cost. At the same time, good shift quality with continuous power transfer and passenger comfort can be achieved. Since fluid drive uses fluid to transfer speed and torque, its self-adaptive characteristics can maintain smoothness to avoid harsh shift feel so that the electronic control can be simpler. It is important to point out that the fluid drive is only used for shifting the gears and not used to drive the vehicle frequently as conventional automatic transmissions do. Therefore, high efficiency is achievable as being similar to automated manual transmission.

What is claimed is:

1. A multi-step automatic transmission comprising:
an input shaft;
an output shaft;
a transmission housing;
a gear system including first gear subsystem with first input shaft and second gear subsystem with second input shaft;
a shift support system having an input which is continuously interconnected with said input shaft;
a first torque transmitting mechanism continuously interconnecting with said first input shaft and selectively interconnecting with members of said first and third gear sets;
a second torque transmitting mechanism continuously interconnecting with said output shaft and selectively interconnecting with members of said second and fifth gear sets;
a third transmitting mechanism continuously interconnecting with said output shaft and selectively interconnecting with members of said fourth and sixth gear sets;
a fourth torque transmitting mechanism continuously interconnecting with said first input shaft and selectively interconnecting with member of said reverse gear set.

2. The transmission defined in claim 1, wherein said first and second gear subsystems haring a common output shaft;
said first subsystem having first, third and fifth gear sets and a reverse gear set;
said second subsystem having second, fourth and sixth gear sets.

3. The transmission defined in claim 1, wherein said four torque transmitting mechanisms comprise synchronizers.

4. The transmission defined in claim 3, wherein the selected synchronizers are engaged prior to gear shifting to achieve shift without torque interruption.

5. The transmission defined in claim 1, wherein said shift support system includes a fluid drive;
said fluid drive, which can be a fluid coupling or a modified torque converter, having an impeller and a turbine.

6. The transmission defined in claim 1, wherein said shift support system includes first and second coupled clutch assemblies.

7. The transmission defined in claim 6, wherein each of said first and second coupled clutch assemblies includes first and second clutches;
each of said first and second clutches including driving clutch discs and driven clutch discs;
said first driven clutch discs being continuously interconnected with said second driven clutch discs in said first coupled clutch assembly;
said first and second driven clutch discs in said first coupled clutch assembly being continuously interconnected with said first input shaft of said first gear subsystem;
said first driving clutch discs in said first coupled clutch assembly being selectively interconnected with said fluid drive impeller;
said second driving clutch discs in said first coupled clutch assembly being selectively interconnected with said fluid drive turbine;
said first driven clutch discs being continuously interconnected with said second driven clutch discs in said second coupled clutch assembly;
said first and second driven clutch discs in said second coupled clutch assembly being continuously interconnected with said second input shaft of said second gear subsystem;
said first driving clutch discs in said second coupled clutch assembly being selectively interconnected with said fluid drive impeller;
said second driving clutch discs in said second coupled clutch assembly being selectively interconnected with said fluid drive turbine.

8. The transmission defined in claim 7, wherein said first coupled clutch assembly is applied for first, third, fifth and reverse speed ranges, and said second coupled clutch assembly is applied for second, fourth and sixth speed ranges.

9. The transmission defined in claim 1, wherein a four-step shift process by electronic control is applied for preparation for shift, first transition, second transition and completion of shift.

10. The transmission defined in claim 1, wherein a three-step launching process by electronic control is applied for preparation for shift, transition and completion of shift.

11. A multi-step automatic transmission, which is derived from the multi-step automatic transmission defined in claim 1 without fifth and sixth gear sets, comprising:
an input shaft;
an output shaft;
a transmission housing;
a gear system including first gear subsystem with first input shaft and second gear subsystem with second input shaft;
a shift support system having an input which is continuously interconnected with said input shaft;
a first torque transmitting mechanism continuously interconnecting with said first input shaft and selectively interconnecting with members of said first and third gear sets;
a second torque transmitting mechanism continuously interconnecting with said output shaft and selectively interconnecting with members of said second and fourth gear sets;
a third torque transmitting mechanism continuously interconnecting with said first input shaft and selectively interconnecting with member of said reverse gear set.

12. The transmission defined in claim 11, wherein the same shift support system defined in claim 6 is used by four-step shift process defined in claim 9 and three-step launching defined in claim 10.

13. A multi-step automatic transmission, which is derived from the multi-step automatic transmission defined in claim 1 without sixth gear set, comprising:
an input shaft;
an output shaft;
a transmission housing;
a gear system including first gear subsystem with first input shaft and second gear subsystem with second input shaft;
a shift support system having an input which is continuously interconnected with said input shaft;
a first torque transmitting mechanism continuously interconnecting with said first input shaft and selectively interconnecting with members of said first and third gear sets;
a second torque transmitting mechanism continuously interconnecting with said output shaft and selectively interconnecting with members of said second and fifth gear sets;
a third transmitting mechanism continuously interconnecting with said output shaft and selectively interconnecting with members of said fourth gear set;
a fourth torque transmitting mechanism continuously interconnecting with said first input shaft and selectively interconnecting with member of said reverse gear set.

14. The transmission defined in claim 13, wherein the same shift support system defined in claim 6 is used by four-step shift process defined in claim 9 and three-step launching defined in claim 10.

15. A multi-step automatic transmission, which is derived from the multi-step automatic transmission defined in claim 1 with additional gear set, comprising:
an input shaft;
an output shaft;
a transmission housing;
a gear system including first gear subsystem with first input shaft and second gear subsystem with second input shaft;
a shift support system having an input which is continuously interconnected with said input shaft;
a first torque transmitting mechanism continuously interconnecting with said first input shaft and selectively interconnecting with members of said first and reverse gear sets;
a second torque transmitting mechanism continuously interconnecting with said first input shaft and selectively interconnecting with members of said third and fifth gear sets;
a third transmitting mechanism continuously interconnecting with said output shaft and selectively interconnecting with members of said seventh and second gear sets;
a fourth torque transmitting mechanism continuously interconnecting with said output shaft and selectively interconnecting with member of said fourth and sixth gear sets.

16. The transmission defined in claim 15, wherein the same shift support system defined in claim 6 is used by four-step shift process defined in claim 9 and three-step launching defined in claim 10.
